(19) United States
(12) Patent Application Publication
(10) Pub. No.: US 2010/0180087 A1
(43) Pub. Date: Jul. 15, 2010

(54) METHOD FOR ACCELERATING INTERNET SMALL COMPUTER SYSTEM INTERFACE DATA AND PROCESSING SYSTEM THEREOF

(75) Inventors: Ming-Sheng Zhu, Tianjin (CN); Yun-Song Wang, Tianjin (CN); Tom Chen, Taipei (TW)

Correspondence Address: APEX JURIS, PLLC, 12733 LAKE CITY WAY NORTHEAST, SEATTLE, WA, 98125, US

(73) Assignee: INVENTEC CORPORATION, Taipei (TW)

(21) Appl. No.: 12/353,097

(22) Filed: Jan. 13, 2009

(51) Int. Cl. G06F 12/00

(52) U.S. Cl. 711/154; 711/E12.001

(57) ABSTRACT

A communication method for accelerating Internet small computer system interface data and a processing system thereof are used for sending a plurality of data packets to a plurality of storage devices by a target of the Internet small computer system interface. The communication method includes the following steps. An access request for accessing the storage devices is received by the target. A plurality of small computer interface commands is generated according to the access request. The small computer interface commands are read by an egress packet generator in the target. An address resolving procedure is performed by the egress packet generator for converting the small computer interface commands to a plurality of network packets. A first check code is generated according to a storage content in each network packet. The first check codes are added to the network packets.

### BACKGROUND OF THE INVENTION

1. Field of Invention

The present invention relates to a processing method for a network packet, and more particular to a processing method for a network packet in an Internet small computer system interface storage device.

2. Related Art

The Internet Small Computer Systems Interface (iSCSI) is a communication protocol standard proposed by the IETF. The iSCSI connects multiple computer hosts in a network through the TCP/TP communication protocol, so as to serially connect multiple storage devices distributed in the Internet into a virtual network storage device. Users can access the network storage device as if they are accessing a local hard disk apparatus. In comparison with conventional SCSI and RAID techniques, the iSCSI technique has the high speed transmission capability of the SCSI, and can extend the capacity of the virtual storage device without being limited to the extension/backup capability of the storage devices. The virtual storage device is called a storage area network (SAN), which is composed mainly by an initiator and a target. The initiator sends an access request for establishing a session with the target. The target may be regarded as an administrator/distributor of the available storage apparatus resources of the network, and can assign corresponding logic unit numbers (LUNs) to a plurality of storage apparatuses. The LUNs are similar to virtual logical volumes, and each LUN is corresponding to a physical storage device on one or more networks.

After the system receives the access request from the initiator, the target stores the packet payload in the access request in a memory of the target. In the prior art, the packet payload is converted to transformer control protocol (TCP) packets in different layers, and the packets are mapped to a firmware layer of a network card. Finally, the packets are sent to the storage device by the firmware layer of the network card through an egress packet generator. FIG. 1 is a schematic view of a process for forwarding packets in the prior art. Referring to FIG. 1, the top of FIG. 1 is a memory space in the target, which is used for storing the access request and corresponding small computer system interface commands; the middle of FIG. 1 is a firmware layer of a network card, which is used for copying the packet payload of the memory of the target to the firmware layer; finally, corresponding check codes are added to the encapsulated packets in the firmware layer by an egress packet generator on the network card. However, according to this process, the data must be mapped and forwarded in layers from the memory of the target. Therefore, much time and memory space are required in the target.

### SUMMARY OF THE INVENTION

In view of the above problems, the present invention is directed to a communication method for accelerating Internet small computer system interface data, which is used for sending a plurality of data packets to a plurality of storage devices by a target of the Internet small computer system interface.

To achieve the above objective, the communication method for accelerating Internet small computer system interface data of the present invention includes the following steps. An access request for accessing storage devices is received by a target. A plurality of small computer interface commands is generated according to the access request. The small computer interface commands are read by an egress packet generator in the target. An address resolving procedure is performed by the egress packet generator for converting the small computer interface commands to a plurality of network packets. A first check code is generated according to a storage content in each network packet. The first check codes are added to the network packets.

In another aspect of the present invention, the present invention is directed to a processing system for network packets of an Internet small computer system interface, which is used for transporting and processing a plurality of network packets among Internet small computer system interface storage systems.

To achieve the above objective, the processing system for network packets of an Internet small computer system interface of the present invention includes an initiator, storage devices, and a target. The initiator is adapted to send an access request. The storage devices are adapted to store target information. The target receives the access request from the initiator, and accesses the target information in the storage devices according to the access request and transports the target information to the initiator.

In the network packet transporting method of the present invention, the check codes for the network packets are generated by utilizing a network card in the target. Thus, the time and memory space for the target to map the access request to the network card are reduced.

### BRIEF DESCRIPTION OF THE DRAWINGS

The present invention will become more fully understood from the detailed description given herein below for illustration only, and thus are not limitative of the present invention, and wherein:

FIG. 1 is a schematic view of a process for forwarding packets in the prior art;

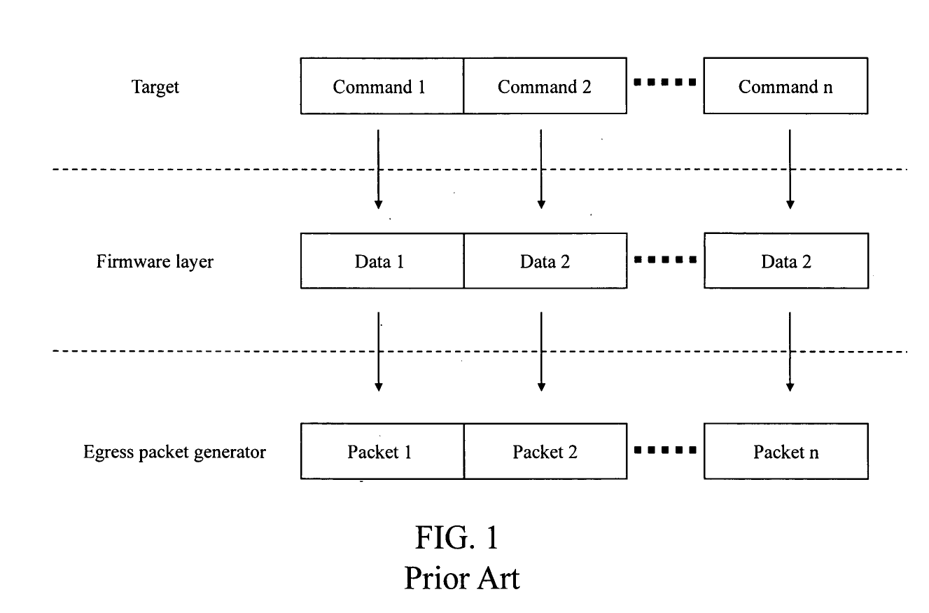

FIG. 2 is a schematic view of the architecture of the present invention;

FIG. 3A is a schematic flow chart of the operation of the present invention;

FIG. 3B is a schematic view of a data packet of an Internet small computer system interface;

FIG. 3C is a schematic view of the architecture of the network packet with a first check code;

FIG. 4 is a schematic flow chart of the operation of another implementation aspect of the present invention; and

FIG. 5 is a schematic view of calculating check codes for addresses commanded by the small computer interface respectively.

### DETAILED DESCRIPTION OF THE INVENTION

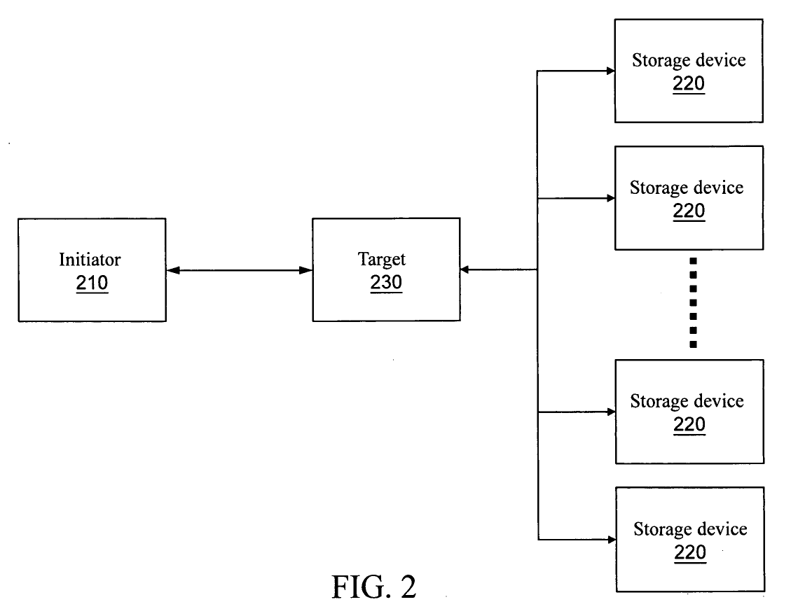

FIG. 2 is a schematic view of the architecture of the present invention. Referring to FIG. 2, a processing system for network packets of an Internet small computer system interface includes an initiator 210, storage devices 220, and a target 230. The initiator 210 is adapted to send an access request. The storage devices 220 are adapted to store target information. The target 230 receives the access request from the initiator 210, and accesses the target information in the storage devices 220 according to the access request and transports the target information to the initiator 210. The target 230, the initiator 210 and the storage devices 220 deliver network packets to one another through the Internet.

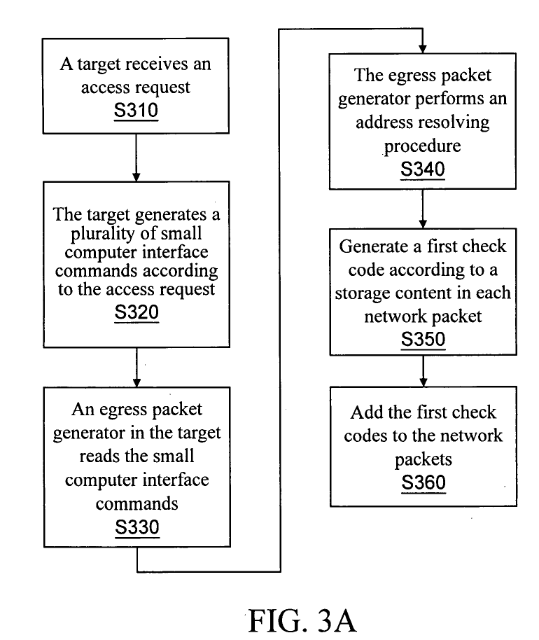

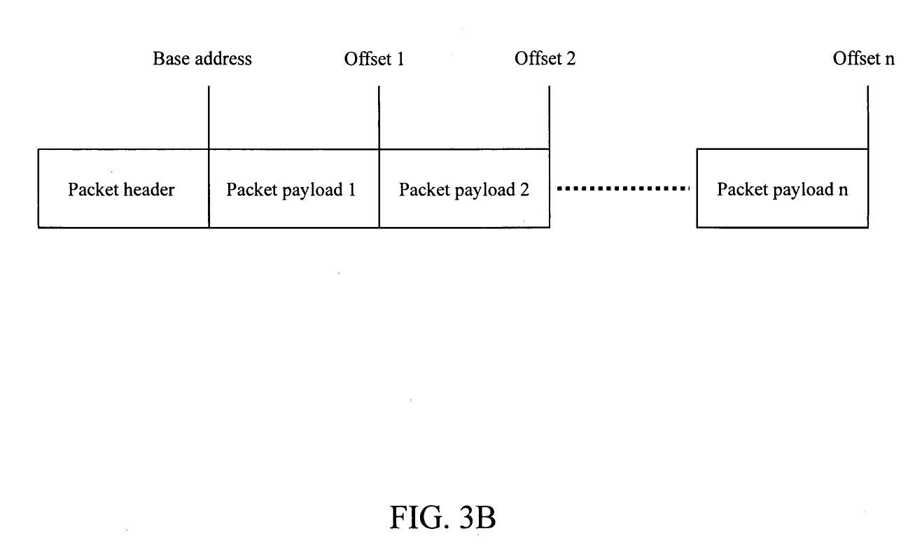

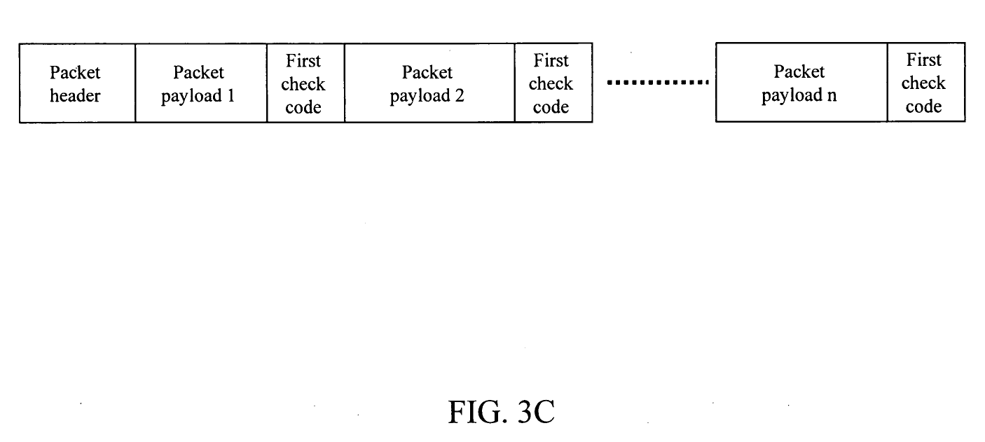

FIG. 3A is a schematic flow chart of the operation of the present invention. Referring to FIG. 3A, a communication method of the present invention includes the following steps. An access request for accessing storage devices 220 is received by a target (step S310). A plurality of small computer interface commands is generated by the target according to the access request (step S320). The small computer interface commands are read by an egress packet generator in the target (step S330). An address resolving procedure is performed by the data egress packet generator (step S340), for converting the small computer interface commands to a plurality of network packets.

The packet information of the Internet small computer system interface is re-segmented after entering the TCP layer. Therefore, the packet information of one Internet small computer system interface may be stored in multiple TCP network packets, or the packet information of multiple Internet small computer system interfaces may be stored in one TCP network packet. Thus, a first check code is generated by the egress packet generator according to a storage content in each network packet (step S350). FIG. 3B is a schematic view of a data packet of the Internet small computer system interface. Referring to FIG. 3B, the first check code is added to the network packet (step S360), and the network packet is sent to a corresponding apparatus. FIG. 3C is a schematic view of the architecture of the network packet with the first check code. Referring to FIG. 3C, for example, the target 230 processes sequentially each network packet in FIG. 3B, that is, a first network packet is processed firstly to generate a first check code, and the first check code is inserted after the first network packet (that is, after the offset 1 in FIG. 3B). Then, the target 230 processes a second network packet, and inserts the generated first check code after the second network packet (that is, after the offset 2 in FIG. 3B). Similarly, the first check code is generated for each network packet, and is inserted after the corresponding network packet.

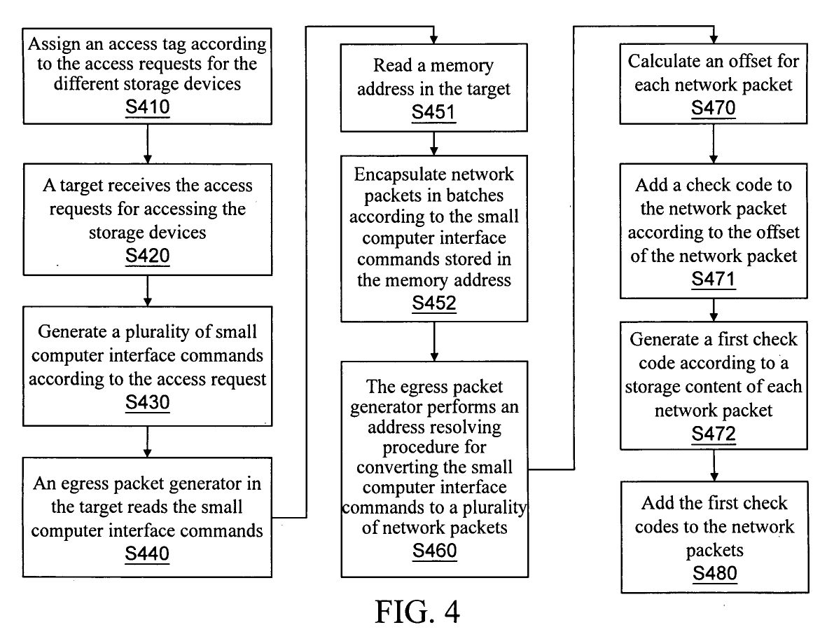

In addition to the situation in which a single initiator 210 sends the request, the present invention may also utilize the access requests of a plurality of initiators 210. FIG. 4 is a schematic flow chart of the operation of another implementation aspect of the present invention. Referring to FIG. 4, another communication method of the present invention includes the following steps. An access tag is assigned according to access requests for different storage devices (step S410). In this implementation aspect, for the access requests initiated by different initiators 210, the access requests from the same initiator 210 are regarded as the same set of access tag. A target receives the access requests for accessing the storage devices (step S420).

A plurality of small computer interface commands is generated according to the access requests (step S430). The small computer interface commands are read by an egress packet generator in the target (step S440). A memory address in the target is read (step S451). Network packets are encapsulated in batches according to the small computer interface commands stored in the memory address (step S452).

An address resolving procedure is performed by the egress packet generator for converting the small computer interface commands to a plurality of network packets (step S460). An offset is calculated for each network packet (step S470). A check code is added to the network packet according to the offset of the network packet (step S471). A first check code is generated according to a storage content of each network packet (step S472). The first check codes are added to the network packets (step S480), and the network packets are sent to a corresponding apparatus.

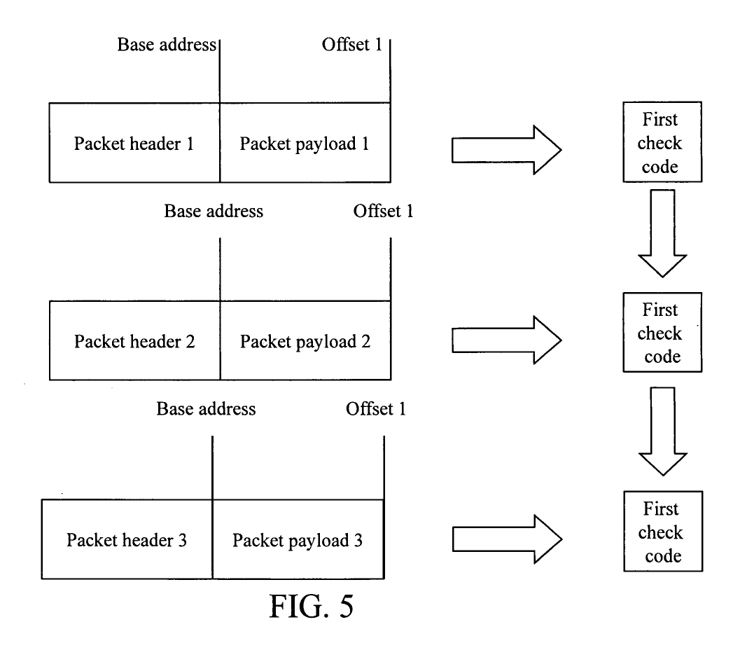

In order to illustrate the operational process when multiple initiators 210 initiate the access requests clearly, the following implementation aspect is described in detail below. It should be noted the number of the initiators 210 is limited in the present invention. A first initiator initiates a first access request; a second initiator initiates a second access request; a third initiator initiates a third access request. The target 230 generates corresponding small computer interface commands (a first small computer interface, a second small computer interface, and a third small computer interface, respectively) according to the different access requests after the target 230 receives the access requests. FIG. 5 is a schematic view of calculating check codes for addresses commanded by small computer interfaces respectively. In FIG. 5, the target 230 first calculates a first check code for a first small computer interface command according to the network packet generated by the first small computer interface command. Then, the target 230 calculates the first check code for a second small computer interface command according to the network packet of the second small computer interface command and the first check code. Similarly, the target 230 calculates the first check code for the third small computer interface command according to the first check code for the first small computer interface command, the first check code for the second small computer interface command and the network packet of the third small computer interface command. The last first check code is defined as a second check code. Finally, when the target 230 sends the above network packets, the second check code obtained above is added after the network packet of the third small computer interface command.

The network packet transporting method of the present invention generates check codes for the network packets by using a network card in the target 230. Thereby, the time and memory space for the target 230 to map the access request to the network card are reduced.

What is claimed is:

1. A communication method for accelerating Internet small computer system interface data, for sending a plurality of data packets to a requester from a target of an Internet small computer system interface, the communication method comprising:
receiving an access request for accessing a storage device by the target;
generating a plurality of small computer interface commands according to the access request;
reading the small computer interface commands by an egress packet generator in the target;
performing an address resolving procedure by the data egress packet generator for converting the small computer interface commands to a plurality of network packets;
producing a first check code according to a storage content in each of the network packets; and
adding the first check codes to the network packets.

2. The communication method for accelerating Internet small computer system interface data according to claim 1, wherein the receiving the access request by the target further comprises:
assigning an access tag according to the access requests for the different storage devices; and
calculating the corresponding first check codes by using the access requests of the same access tag.

3. The communication method for accelerating Internet small computer system interface data according to claim 1, wherein the reading the small computer interface commands further comprises:
reading a memory address in the target; and
encapsulating the network packets in batches according to the small computer interface commands stored in the memory address.

4. The communication method for accelerating Internet small computer system interface data according to claim 1, wherein before the producing the first check code, the communication method further comprising:
calculating an offset for each of the network packets; and
adding the first check code to the network packet according to the offset of the network packet.

5. The communication method for accelerating Internet small computer system interface data according to claim 4, wherein after the calculating the offset, the communication method further comprising:
calculating the first check code for a storage content of the network packet according to the offset.

6. A processing system of an Internet small computer system interface, applicable for transporting and processing a plurality of network packets among Internet small computer system interface storage systems, the processing system comprising:
an initiator, for sending an access request;
a plurality of storage devices, for storing a target information; and
a target, for receiving an access request from the initiator, the target accesses the target information in the storage devices according to the access request and transports the target information to the initiator, wherein the target is further for:
generating a plurality of small computer interface commands according to the access request;
reading the small computer interface commands by an egress packet generator in the target;
performing an address resolving procedure by the egress packet generator for converting the small computer interface commands to a plurality of network packets;
generating a first check code according to a storage content in each of the network packet; and
adding the first check codes to the network packets.
